(19) United States
(12) Patent Application Publication
(10) Pub. No.: US 2016/0295180 A1
(43) Pub. Date: Oct. 6, 2016

(54) PICO PROJECTOR

(71) Applicants: Chen-Ren Yu, HsinChu (TW); Chiao-Sen Hsu, HsinChu (TW)

(72) Inventors: Chen-Ren Yu, HsinChu (TW); Chiao-Sen Hsu, HsinChu (TW)

(73) Assignees: Sintai Optical (Shenzhen) Co., Ltd., Shenzhen City (CN); Asia Optical Co., Inc., Taichung (TW)

(21) Appl. No.: 14/675,751

(22) Filed: Apr. 1, 2015

(51) Int. Cl. H04N 9/31; G03B 21/20

(52) U.S. Cl. CPC H04N 9/3173; H04N 9/317; H04N 9/315; G03B 21/2066; H04N 9/3144

(57) ABSTRACT

A pico projector of the invention includes an illuminating module, an imaging module, and a lens-focusing module. The illuminating module is configured to emit light. The imaging module is configured to add picture messages into the light to generate an image and project the image. The lens-focusing module is configured to regulate a focal length of the imaging module.

### BACKGROUND OF THE INVENTION

1. Field of the Invention

The invention relates to pico projector, and more particularly to a modular pico projector.

2. Description of the Related Art

Pico projectors are more and more popular and even built in various mobile devices, such as mobile phones and tablets, due to its light weight. Various pico projectors are developed in market to satisfy different requirements for brightness, resolution, volume, cost, heat dissipation, focus regulation or projecting angle. However, for each product of pico projectors, manufacturer must correspondingly develop a set of molds, which may elongate development period and cause high cost.

### BRIEF SUMMARY OF THE INVENTION

The invention provides a pico projector. All parts of the pico projector of the invention are modularized. The modularized parts can be selectively combined or assembled to constitute various types of pico projectors according to requirements. Since the pico projectors of different types may have common modularized parts, mold development is thus simplified, manufacturing efficiency is increased, products are diversified and development risk is reduced.

The pico projector in accordance with an exemplary embodiment of the invention includes an illuminating module configured to emit light; an imaging module configured to add picture messages into the light to generate an image and project the image; and a lens-focusing module configured to regulate a focal length of the imaging module.

In another exemplary embodiment, the illuminating module, the imaging module and the lens-focusing module are joined by grooves, screws, mortises, latches and/or adhesive.

In yet another exemplary embodiment, the illuminating module is single light source module, double light source module, triple light source module or laser light source module.

In another exemplary embodiment, the imaging module includes a display panel, a lens, a prism and a seat. The display panel is configured to add the picture messages into the light and the lens projects the image. The lens-focusing module is configured to regulate a focal length of the lens.

In yet another exemplary embodiment, the lens is a long focus lens or a short focus lens.

In another exemplary embodiment, the lens-focusing module includes a lateral focusing module including transmission members (gears, shafts, link, cam, etc.), a motor, rails and a seat. The lens-focusing module can be a front focusing module, a bottom focusing module or a top focusing module.

In yet another exemplary embodiment, the lens-focusing module is a manual-regulating focusing module or an electro-regulating focusing module.

In another exemplary embodiment, the pico projector includes one or more complementary module connected to the illuminating module, the imaging module and/or the lens focusing module.

In yet another exemplary embodiment, the complementary module includes a reflective mirror module, a light engine protecting cover and/or heat dissipation module. The reflective mirror module includes a reflective mirror and a mirror frame. The light engine protective cover includes a reflective mirror protective cover and lens protective cover. The heat dissipation module includes a thermal pad, a heat dissipation sheet and fins.

In another exemplary embodiment, the illuminating module, the imaging module, the lens focusing module and the complementary module are joined by grooves, screws, mortises, latches and/or adhesive.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective exploded view of an embodiment of a pico projector of the invention;

FIG. 2 is a perspective view of a pico projector of FIG. 1;

FIG. 3 is a perspective exploded view of an illuminating module of a pico projector of FIG. 1; and

FIG. 4 is a perspective exploded view of an imaging module of a pico projector of FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

All parts of a pico projector of the invention are modularized. The pico projector includes an illuminating module, an imaging module and a lens-focusing module. The pico projector can further include one or more complementary module according to requirements. The illuminating module, the imaging module, the lens-focusing module and the complementary module are joined to by grooves, screws, mortises, latches and/or adhesive through precisely positioned jigs.

The illuminating module can be a single light source module, a double light source module, a triple light source module or a laser light source module.

The imaging module includes display panels of different sizes, lenses of different projecting angles, a long focus lens or a short focus lens.

The lens-focusing module can be a lateral focusing module, a front focusing module, a bottom focusing module or a top focusing module according to its operational position. The lens-focusing module can be a manual-regulating focusing module or an electro-regulating focusing module according to its driving source.

The complementary module includes a reflective mirror module, a light engine protecting cover, a heat dissipation module. The reflective mirror module includes a reflective mirror and a mirror frame. The light engine protecting cover includes a reflective mirror protecting cover and lens protecting cover. The heat dissipation module includes a heat dissipation sheet and/or fins.

The modules can be selectively combined or assembled to constitute various types of pico projectors according to requirements. Since the pico projectors of different types have common modules, mold development is thus simplified, manufacturing efficiency is increased, products are diversified and development risk is reduced.

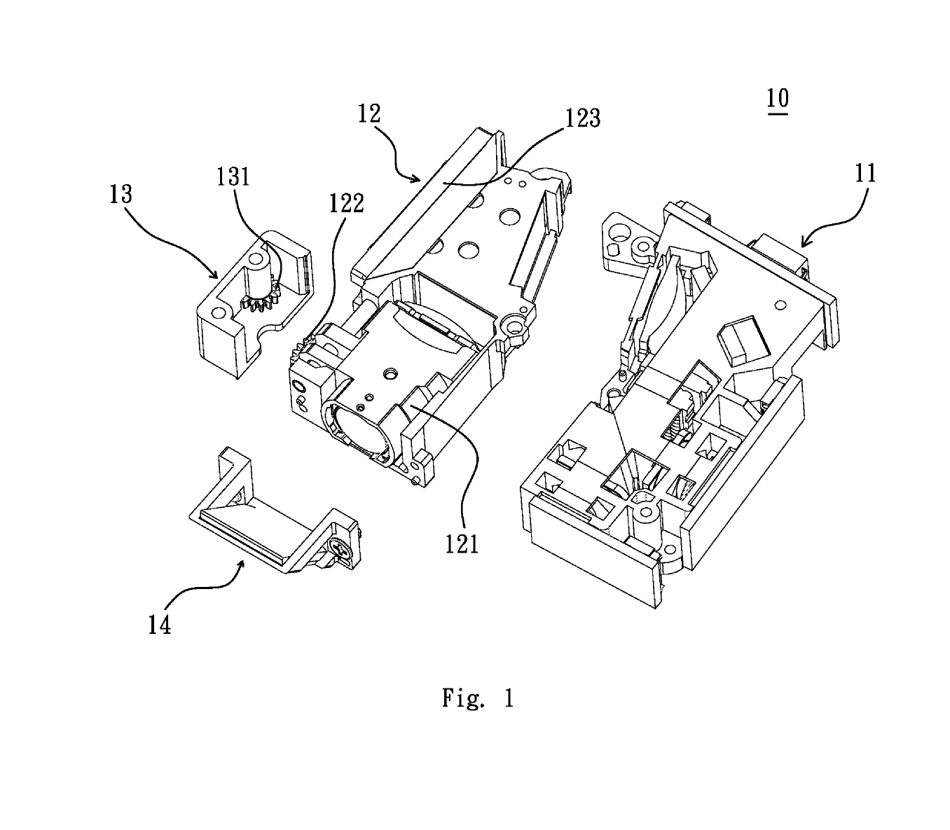

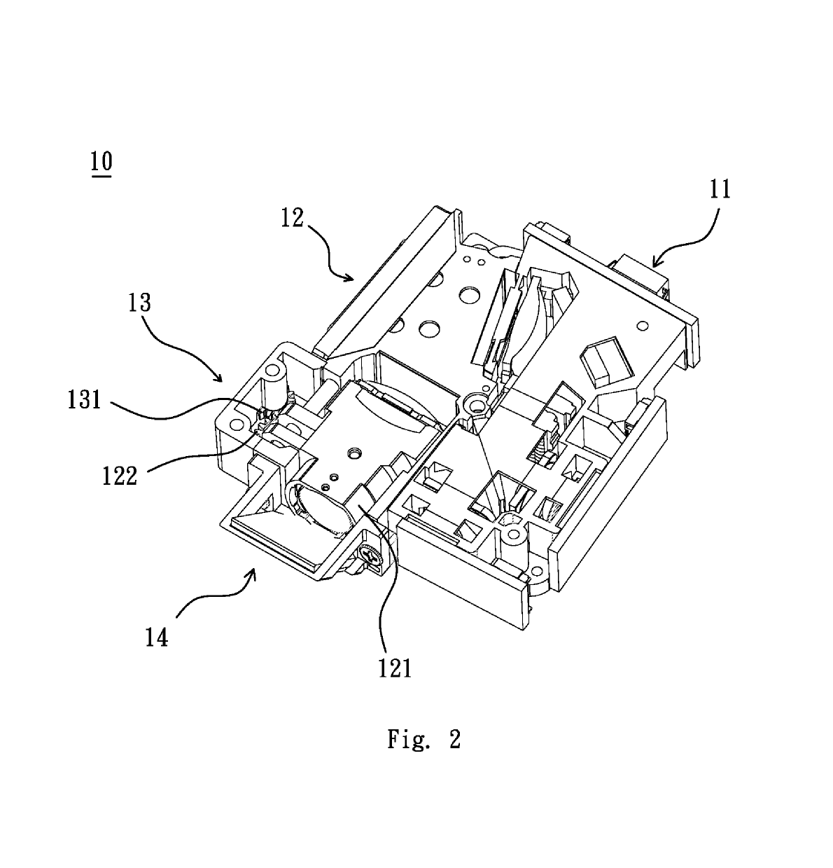

Referring to FIGS. 1 and 2, a pico projector 10 includes an illuminating module 11, an imaging module 12, a lens-focusing module 13 and a reflective mirror module 14. The illuminating module 11, the imaging module 12, the lens-focusing module 13 and the reflective mirror module 14 are joined by grooves, screws, mortises, latches and/or adhesive.

When the pico projector is operated, the illuminating module 11 emits light, and the light is conducted into the imaging module 12. The imaging module 12 includes a display panel 123 and lens 121. The display panel 123 is configured to add a picture message into the light to generate an image, and the image is projected by the lens 121. The lens-focusing module 13 is configured to regulate a focal length of the lens 121. The reflective mirror module 14 is configured to change a projecting direction of the image.

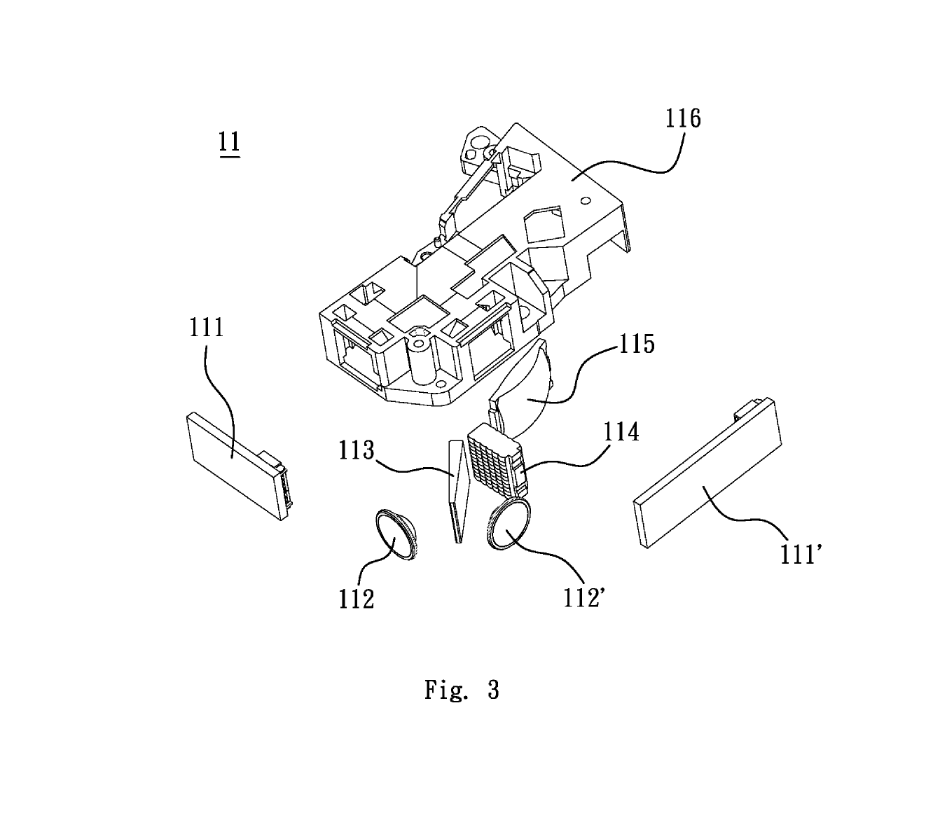

Referring to FIG. 3, in this embodiment, the illuminating module 11 includes light emitting diodes 111 and 111′, collimators 112 and 112′, a splitter 113, a lens array 114, a lens 115 and a seat 116. The seat 116 bears the illuminating module 11. The light emitting diodes 111 and 111′ generate divergent light of different color. The divergent light is converted to a light beams by the collimators 112 and 112′. The splitter 113 configured to combine the light beams is disposed in a position in which the light beams intersect. The combined light beam propagates to the lens array 114. The lens array 114 includes an array of 3×5 spherical or non-spherical small biconvex lenses. The lens array 114 diffuses the light beam uniformly, and the diffused light beam is condensed by the lens 115 and finally emits from the illuminating module 11.

In addition, thermal pads (not shown) can be attached to the light emitting diodes 111 and 111′ for heat dissipation.

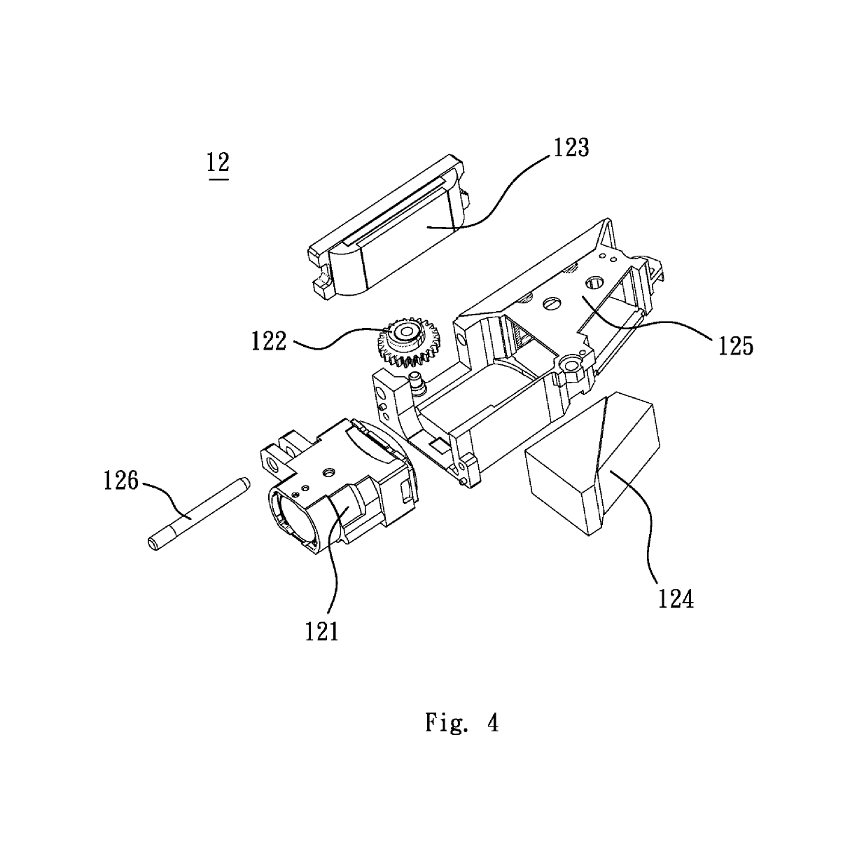

Referring to FIG. 4, the imaging module 12 includes a prism 124, a display panel 123, a lens 121, a transmission member 122, a rail 126 and a seat 125. The seat 125 bears the imaging module 12. The prism 124 receives the light beam from the illuminating module 11, separates polarized light of specific directionality from the light beam and then projects the light beam to the display panel 123. Picture messages are added into the light beam by the display panel 123 to generate an image, and the image is projected through the lens 121. The transmission member 122 drives the lens 121 to move along the rail 126 for focus regulation.

Referring to FIG. 2 again, the lens-focusing module 13 is a manual lateral focusing module. The transmission member 131 disposed on a lateral side of the pico projector 10 moves the transmission member 122 so as to change a position of lenses (not shown) of the lens 121 for focus regulation.

Although the lens-focusing module 13 is a manual-regulating focusing module in this embodiment, it is not limited thereto. The lens-focusing module 13 can be an electro-regulating focusing module in another embodiment, wherein an electrical motor (not shown) is disposed to drive the transmission member 122 of the imaging module 12.

Although the transmission members 122 and 131 are gears in this embodiment, they are not limited thereto. The transmission members 122 and 131 can be shafts, links, cams etc. in another embodiment for power transmission.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A pico projector, comprising:
an illuminating module configured to emit light;
an imaging module configured to add picture messages into the light to generate an image and project the image; and
a lens-focusing module configured to regulate a focal length of the imaging module.

2. The pico projector as claimed in claim 1, wherein the illuminating module, the imaging module and the lens-focusing module are joined by grooves, screws, mortises, latches and/or adhesive.

3. The pico projector as claimed in claim 1, wherein the illuminating module is a single light source module, a double light source module, a triple light source module or a laser light source module.

4. The pico projector as claimed in claim 1, wherein the imaging module comprises a display panel configured to add the picture messages into the light and a lens through which the image is projected, and the lens- focusing module is configured to regulate a focal length of the lens.

5. The pico projector as claimed in claim 4, wherein the lens is a long focus lens or a short focus lens.

6. The pico projector as claimed in claim 1, wherein the lens-focusing module is a lateral focusing module, a front focusing module, a bottom focusing module or a top focusing module.

7. The pico projector as claimed in claim 1, wherein the lens-focusing module is a manual-regulating focusing module or an electro-regulating focusing module.

8. The pico projector as claimed in claim 1 further comprising one or more complementary module connected to the illuminating module, the imaging module, and/or the lens focusing module.

9. The pico projector as claimed in claim 8, wherein the complementary module comprises a reflective mirror module, a light engine protecting cover, or a heat dissipation module.

10. The pico projector as claimed in claim 8, wherein the illuminating module, the imaging module, the lens focusing module and the complementary module are joined by grooves, screws, mortises, latches and/or adhesive.
